(19) United States
(12) Patent Application Publication
(10) Pub. No.: US 2026/0004368 A1
(43) Pub. Date: Jan. 1, 2026

(54) METHOD FOR OPTIMIZING THE ELECTRICAL NETWORK LOAD BY TARGETED CHARGING OF ELECTRIC VEHICLES

(71) Applicant: MAGNA INTERNATIONAL EUROPE GMBH, Wien (AT)

(72) Inventors: Gerald Teuschl, Fernitz-Mellach (AT); Wolfgang EKAM, Graz-Kroisbach (AT)

(21) Appl. No.: 18/881,538

(22) PCT Filed: Jul. 7, 2023
(86) PCT No.: PCT/EP2023/068877

§ 371 Date: Jan. 6, 2025

(30) Foreign Application Priority Data
Jul. 7, 2022 (DE) 10 2022 206 967.6

(51) Int. Cl. G06Q 50/02; G06Q 10/067

(52) U.S. Cl. CPC G06Q 50/02; G06Q 10/067

(57) ABSTRACT

A method for optimizing the network load in at least one predefined sector of an electrical network of at least one network operator using a prediction model for load management, wherein there is a network operator interface to the network operator and the data and information from model calculations and individual data from users of a service provider are used, wherein individual communication is performed at least with the users that can provide power in the sector.

### CROSS-REFERENCE TO RELATED APPLICATIONS

This application is a National Stage of International Application No. PCT/EP2023/068877, filed Jul. 7, 2023, which claims priority to DE 102022206967.6, filed Jul. 7, 2022. The entire disclosures of each of the above applications are incorporated herein by reference.

### FIELD OF THE INVENTION

The invention relates to a method for optimizing the network load in at least one predefined sector of an electrical network of at least one network operator, using a prediction model for load management.

The invention further relates to a service package for a network operator and subscribed users of a service provider, and to a business model for the supply and commercial sale of calculated data from a prediction model, and from subscribed users.

### BACKGROUND OF THE INVENTION

This section provides information related to the present disclosure which is not necessarily prior art.

Although renewable energy sources are assuming increasing significance, the injection thereof into networks fluctuates, and does not proceed in parallel with movements in energy demand. Electric vehicles can deliver a critical contribution to the resolution of resulting problems. In order to enable the exploitation of the potential of renewables, storage technologies are required. The batteries of electric vehicles provide an option for this purpose. Electromobility and network integration are thus key pillars of sustainability, and are simultaneously a central field of political activity.

By the employment of the vehicle a mobile store, an energy flux between a network and an electric vehicle can be executed in two directions: during periods of surplus energy, vehicle batteries can be employed as stores in the grid-to-vehicle (G2V) direction whereas, during periods of high energy demand, energy can be returned to the network in the vehicle-to-grid (V2G) direction. However, the term vehicle-to-grid (V2G) is also employed—particularly internationally—to describe the superordinate concept of the network integration of electric vehicles, which incorporates both directions of flow, from “grid-to-vehicle” and from “vehicle-to-grid”.

Vehicle-to-grid is understood as a concept for the release of electric power from the traction batteries of electric and hybrid vehicles back into the public electrical network. Vehicle-to-home operates by the same principle although, in this case, electric power is not re-injected into the public network, but into a private domestic electrical network.

Both concepts require that a bidirectional energy management by the charging station is enabled. Conversely to conventional e-vehicles, bidirectionally chargeable vehicles can not only extract electrical energy from the network but, in the reverse direction, as part of an intelligent energy system, can also inject power from a vehicle battery into the network via special charging stations during periods of high network capacity utilization.

Vehicle-to-Grid is a critical key to the future supply of energy, for a number of reasons: increasing numbers of electric cars are driving on German and European roads, thus driving a rising demand for electricity. At the same time, however, in the medium term, an increasing number of power plants which inject consistent quantities of electricity are being decommissioned from the grid. In particular, these include nuclear and coal-fired power plants. In the context of energy transition, these are being replaced by renewable energy, in particular by wind turbine installations and solar energy. Both of the latter are highly susceptible to fluctuation, as reflected in the energy mix, for example of Germany.

The large number of electric vehicles can contribute to the resolution of these fluctuations: the vehicle-to-grid (V2G) concept is based upon the take-up of surplus power by electric cars and the subsequent re-injection thereof into the network in the event of a power shortfall.

A pilot trial conducted by Porsche and the transmission system operator TransnetBW is known, wherein the employment of the high-voltage batteries of electric cars as intelligent buffer stores is enabled.

A core element of data communication in this pilot trial is a cloud-based pooling system developed by IE2S. This system coordinates the charging processes of electric vehicles. Controlling power target values of the network operator are translated into vehicle-specific signals, which control charging processes in real time. Moreover, the pooling system controls high-frequency and time-synchronized bidirectional data transmission.

A substantial risk and a major uncertainty factor for network operation by the network operators involved is represented by newly arising loads, e.g. associated with the uncontrollable timing of charging processes of electric vehicles. It is therefore critical for a network operator to know how many electric vehicles are being charged in their network.

One source of information for the network operator is thus a monitoring of electric vehicle models which are available on the market, or the market run-up thereof. These data can be employed to enable network operators to prepare their networks in accordance with the run-up of electric vehicles, and provide improved security of planning.

However, as not all charging processes and the resulting loads for the network operator are plannable, the provision of legal and technical facilities is required for the integration of intelligent charging or load management. An option is thus provided for the staggering of charging processes over time, and for the relief of the network load, if necessary.

For the exercise of this influence over charging processes, a wide variety of approaches are under discussion, ranging from local load management through to bidirectional charging.

The following concepts are critical to network management:

Network compatibility describes the fundamental prerequisite for the connection of an installation to the public electrical network. This concept forms the basis of network utility and system utility. System utility contributes to the maintenance of the stability of the electricity system, and is predominantly supported by transmission system operators.

For the illustration of the above-mentioned definition of network integration, the two concepts of network compatibility and network integration are applied to the current situation.

In the case of network compatibility, load management or charging management is already executed by customers—particularly in the commercial sector—in the interests of compliance by the subscriber with contractual obligations which are agreed with the network operator. In this case, there is no intervention in, or actuation of the customer installation by the network operator, such that the latter has no influence upon current capacity.

In general, network utility is presently implemented on the basis of an agreement concluded under the terms of § 14a of the German Energy Management Act (“Energiewirtschaftsgesetz” or “EnWG”) between the network operator and the subscriber. In the context of their own load monitoring, the network operator influences the load behavior of the subscriber, for example by means of time/load windows, ad hoc control signals and financial incentives. In this case, the customer installation implements corresponding information from the network operator. Financial incentives of the network operator, in the form of reduced network access charges, are passed on by the supplier/aggregator to the subscriber.

At present, a central control of network interconnection is executed by the network operator, thus incorporating a demand management-based injection of energy, employing predictive models of use. This model can be classified as fully-developed and reliable. In response to the increase in mobile high-current and high-energy loads, such as battery electric vehicles, these anticipatory transfer operations (re-/dispatch) and capacity adjustments are increasingly disturbed.

Resulting deficiencies in the electrical network include increasing energy costs associated with the additional requirement for network expansion, network instability, a negative impact upon customers associated with the removal of vehicles from the network and the resulting unscheduled interruption of charging, and restrictions on the plannability of the network configuration and network load resulting from local, regional and national load movements, together with the associated increase in infrastructure costs and environmental impacts.

### SUMMARY OF THE INVENTION

This section provides a general summary of the disclosure, and is not a comprehensive disclosure of its full scope or all of its features.

The object of the invention is the execution, on loads, of an improved forecasting of the future location-dependent network capacity and energy demand of mobile loads which are connected to the system.

This object is fulfilled by a method for optimizing the network load in at least one predefined sector of an electrical network of at least one network operator, using a predictive model for load management, wherein a network operator interface to the network operator is provided, and data and information from model calculations and individual data from users of a service provider are employed, wherein individual communication is executed at least with users who are capable of supplying power in the sector.

Data employed for prediction can be significantly improved, if current data are available to end users. As an addition to previously known predictive models, which exclusively employ historical data, a component is provided in the present case which is based upon individual final customers.

The object is also fulfilled by a method for the transfer of data to a network operator for a predictive model, wherein a network operator interface is provided and data and information are generated from model calculations of an environment model and a fleet model for a predefined network region, wherein the fleet model includes sub-models comprised of a customer preference user model, a utilization group model, a charging column model, a vehicle model and a driver model.

The multiplicity of models employed model a data image from the multiplicity of available data, which is employed by the network operator for their prediction.

The network operator defines a sector by means of a network load model and

a network node model.

The service provider assumes the role of the provision of services to subscribed users, and the delivery of further services to the at least one network operator.

Users supply and consume power wherein, in this context, there are users having their own photovoltaic installations and their own charged vehicle batteries, or users who only operate one or more electric vehicles.

The service provider operates an incentive model, which offers financial incentives or privileges to subscribed users, either on the Internet or in real space.

The object is also fulfilled by a service package which is set-up by means of the method, comprising data from calculated models which are consolidated into a predictive model which is provided to network operators for the network operation thereof, and a service provision package for subscribed users and at least one network operator.

The object is also fulfilled by a business model for the supply and commercial sale of calculated data from a predictive model for a network operator and subscribed users.

By means of the method, network and energy costs are minimized by more effective prediction, while consumption, and thus also CO2 output, are optimized.

More effective prediction results in improved network stability and a reduction of network outage probabilities.

The customer is provided with an advantage, in that the interruption of their charging process is less probable.

Further areas of applicability will become apparent from the description provided herein. The description and specific examples in this summary are intended for purposes of illustration only and are not intended to limit the scope of the present disclosure.

### DRAWINGS

FIG. 1 is a diagram of an embodiment of the invention according to an aspect of the disclosure

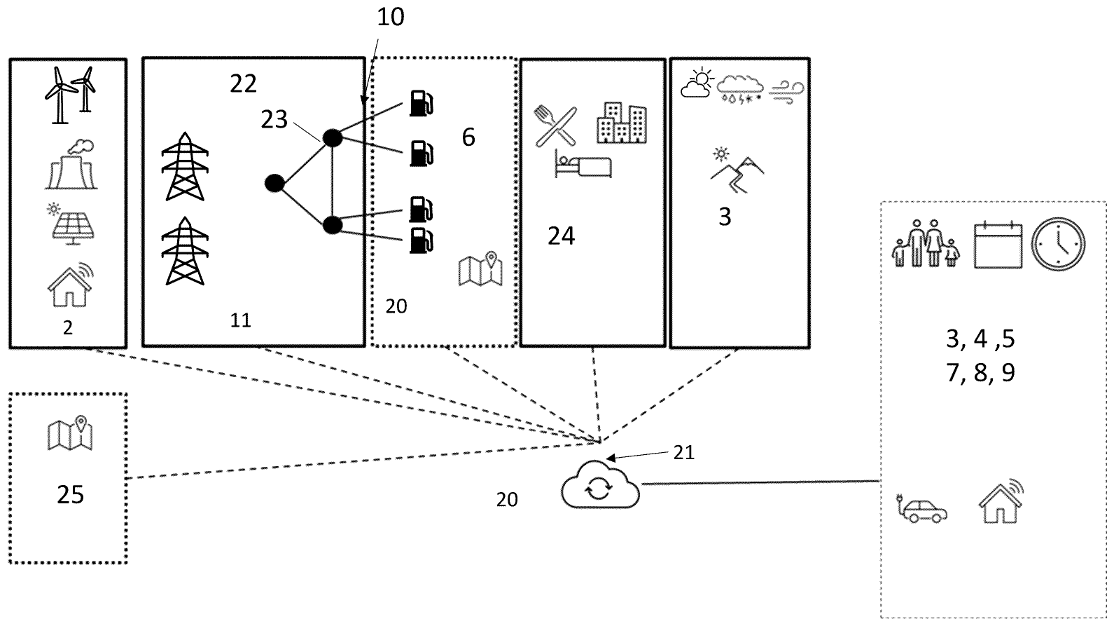

### DESCRIPTION OF THE INVENTION

Both conventional and novel conceptual and modelling approaches to prediction are involved in theoretical modelling methods. The object of a model is the systematic investigation and description of connections between influencing variables and incentivizing variables.

A forecast of the future characteristic of the incentivizing variable on the system, according to influencing variables, proceeds from the generation of a model.

The predictive model of energy demand in the system of the network operator 1, on the energy supply side, is associated with information on the energy supplier 2. This also involves decentralized generators, which are subdivided into two categories: dispatchable generators and non-dispatchable generators.

Whereas combined heat and power plants represent dispatchable generators, windfarms and photovoltaic installations are classified as non-dispatchable decentralized generators.

For the purposes of prediction, the focus is directed to non-dispatchable decentralized generators. By means of predictive models, the power generation thereof can be ascertained a certain time in advance. This enables electric vehicles to be incorporated in scheduling such that they are charged during periods of high generation, and charging is interrupted when less power is produced. If a photovoltaic installation or windfarm is e.g. an element of a business complex, consumption of self-generated power can also be increased accordingly. Prediction of scheduled generation is strongly dependent upon weather forecasting models. Wind speed thus dictates the power production of wind turbine installations. Power production from solar installations also varies according to the duration of irradiation, the intensity and incident angle of solar radiation. As a result, power generation from renewable energy sources can vary substantially within a short period of time, e.g. in the case of photovoltaic installations, as a result of cloud coverage of the sun. By means of weather forecasts, such fluctuations can be predicted and thus promptly incorporated in scheduling, although the accuracy of such predictions is limited. This can result in instabilities in the network, which can be offset by the judicious employment of flexible loads.

The predictive model according to the invention is based upon data and sub-models which are generated by electric vehicles, and which are employed as the starting point for sub-models. A prerequisite for this purpose are rechargeable vehicles having a facility for the supply of information with respect to the position thereof, their destination, the user or the behavior thereof, and user preferences.

Further electric vehicle data also include the vehicle type, including the model, battery size and capacity, and power status information, which represents charging demand or the facility for discharging.

Additionally, an environmental model 3 is employed for the predictive model 1, which contains information on current local weather conditions supplied by vehicles. The environmental model 3 is additionally capable of representing a route of an electric vehicle in a network sector, and of employing traffic density along the route as a parameter.

Additionally to specifically generated data for an individual user of an electric vehicle, a customer preference user model 4 is employed. This customer preference user model 4 comprises at least information with respect to the temporal use of the electric vehicle and its known and most probable routes. Driving profiles are thus generated with respect to capacities, energy consumption and the route section, e.g. information on gradients. A situational response such as, for example, a response to traffic density data, is also captured. A regular route can thus be adjusted, in the event that a traffic jam occurs and the user employs a consistent deviation route.

Data on charging behavior are also incorporated in the customer preference user model 4. Charging profiles are detected automatically. By way of an additional or singular data capture, it is also provided that a customer interface is employed for the input of preferences on charging points, distance from destination, adaptation of charging profiles to the charging time, charging energy and charging power.

The predictive model 1 also employs a utilization group model 5, which is dynamically structured by the correlation of equivalent utilization groups and/or equivalent user behavior.

A further sub-model is a charging column model 6, which delivers weather information, occupancy data, functional and capacity data, together with type information on charging columns.

One sub-model represents a vehicle model 7 for determining the state-of-charge at the end of the journey, which is also based upon a prediction.

A driver model 8 for ascertaining the anticipated route and individual driver behavior enables a further improvement in the estimation of anticipated energy consumption.

Information and outcomes from sub-models are consolidated in a fleet model 9, which aggregates available and calculated data, in order to execute the delivery and transfer, at the network operator interface 10, of a forecast for the future anticipated location-based power and energy demand.

The predictive model 1 is populated with data, on the basis of data from the fleet model 9, which population is executed exclusively by means of a cloud-based system for the calculation of models.

The network operator 11 themselves provides a network operator interface 10 for inputting the foreseeable network load associated with mobile loads which are connected to the system.

Data for the predictive model are transferred to the network operator 11 in the form of a service package. A service provider 20 can thus sell data to the network operator.

The logging of data in the above-mentioned manner, the calculation of models, the consolidation of models and the final calculation are all executed by means of Internet connections to the service provider in the network.

The availability of data is a first key step on the road towards an active control of network capacity utilization for the network operator 11. Over and above purely statistical data, data on individual users—as described—are also available.

For an optimization of network occupancy and network capacity utilization, individual data in individual sectors are retrieved, optionally in a highly localized manner.

In a further step, individual consumers or groups of consumers who have registered as users with the service provider are encouraged to implement a change of behavior by means of an incentive system.

The method commences with the inputting of user profiles in a specific sector and information from the model calculations of the service provider 20. In the sectors, models of the electrical network are employed as the network model 22, and models of network nodes are employed as the network node model 23.

Energy suppliers 2 and network operators 3 also supply data to service providers, which are comprised of an optimum current and future network load, and energy costs resulting therefrom. Further data sources, such as navigation data and route calculations, are also incorporated by the service provider.

The service provider contacts subscribed users, and delivers status information thereto.

In the context of communication with users, for example, users who operate a power source, or “prosumers”, are invited to inject power into the relevant sector of the network. In order to enhance an inclination for the injection of power, this invitation is associated with an incentive. The incentive is a monetary incentive, or an advantage associated with the current or future use of the network.

An incentive model 24 comprises a wide variety of offers. These include concessions for food and drink, or for overnight accommodation. The provision of parking spaces is a further option for the delivery of incentives.

All service activities on the Internet, via their respective platforms, can be employed for the generation of incentives. Gaming platforms provide a basis for the provision of gaming benefits, by way of an incentive.

On the basis of available static and dynamic data, and further network parameters such as:
a. Information from the customer preference model,
b. An estimation of present and foreseeable use,
c. The availability of energy within the sector, or externally,
d. The efficiency of individual elements and of the entire system chain, with effect from the network connection,
e. The vehicle,
f. Weather data,
g. Routes,
a local, regional and national present and future network demand value for mobile sources/loads is calculated by means of a virtual model of the individual user and of aggregated utilization groups in the local, regional and national context, and is harmonized with the location-based network and energy data.

By way of an outcome, either a surplus or a shortfall of energy in the selected sector will then be in force.

It is therefore necessary for an incentive 24 to be activated by the service provider 20, in order to alter the behavior of users such that network capacity utilization is optimized.

On the basis of deficits and surpluses, a calculation of grams of CO2/kWh for present and future consumption, energy costs, driving times and stationary times, and on the basis of customer preferences of users having the facility for the local injection of power, users are actively directed by means of an incentive system, in the interests of achieving the respectively desired optimum outcome.

Encouragement must be delivered to the vehicle user for the acceptance of the charging incentive signal of the service provider. Only in the event of a sufficient acceptance, on the part of the vehicle user, of additional marginal conditions associated with the charging incentive during charging can the full potential of V2G be exploited.

If the charging incentive is defined in the form of a variable electricity price, a comprehensible incentive model can be presented to the vehicle user. The charging process is thus executed at a time point when, according to the charging incentive function, energy is available at a favorable price. The advantage of compliance with the charging incentive function is thus evident, as the vehicle owner is financially rewarded during charging, on the basis of the incentive function, and can obtain cost-effective charging.

Conversely, for the energy network operator, it is important to ensure the achievement of a reliable charging behavior on the part of electric vehicles. This is only possible if the degree of freedom in the charging process, from the perspective of the energy network operator, is restricted. If an incentive is offered to the vehicle user for the execution of beneficial charging at a specific time point, the charging process can thus be forecast more effectively, from the perspective of the energy network operator. The latter can thus calculate more accurate load forecasts and ensure an improved network quality, together with a reduction in demand for controlling power.

By way of an incentive 24, over and above exclusively financial compensation, an issue of credits can be executed by firms who are also subscribers to the service provider, and who thus wish to canvass customers.

### REFERENCE NUMBERS

1 Predictive model
2 Energy supplier
3 Environmental model
4 Customer preference user model
5 Utilization group model
6 Charging column model
7 Vehicle model
8 Driver model
9 Fleet model
10 Network operator interface
11 Network operator
20 Service provider
21 Internet interface
22 Network model
23 Network node model
24 Incentive model
25 External data suppliers

What is claimed is:

1. A method for optimizing the network load in at least one predefined sector of an electrical network of at least one network operator, using a predictive model for load management, wherein a network operator interface to the network operator is provided, and data and information from model calculations and individual data from users of a service provider are employed, wherein individual communication is executed at least with users who are capable of supplying power in the sector.

2. The method for optimizing the network load as claimed in claim 1, wherein a network operator interface is provided and data and information are generated from model calculations of an environment model and a fleet model for a predefined network region, wherein the fleet model includes sub-models comprised of a customer preference user model, a utilization group model, a charging column model, a vehicle model and a driver model.

3. The method as claimed in claim 1, wherein the sector is defined by a network load model and a network node model.

4. The method as claimed in claim 1, wherein the service provider assumes the provision of services to subscribed users, and the delivery of further services to the at least one network operator.

5. The method as claimed in claim 1, wherein users both supply and consume power.

6. The method as claimed in claim 1, wherein the network operator actively controls their network in the sector, by means of the service provider, such that network capacity utilization at any time is optimized.

7. The method as claimed in claim 1, wherein the service provider operates an incentive model which offers financial incentives or privileges to subscribed users, either on the Internet or in real space

8. The method as claimed in claim 2, wherein the environmental model contains information on current local weather conditions supplied by vehicles, and is additionally capable of representing a route of an electric vehicle in a region of the predetermined network sector, and of employing traffic density along the route as a parameter, the customer preference user model comprises at least information with respect to the temporal use of the electric vehicle and its known and most probable routes, situational responses to traffic conditions and data on charging behavior, wherein data on charging behavior is detected automatically by way of charging profiles and/or a data capture for the user is provided, wherein a customer interface is employed for the input of preferences on charging points, distance from destination, adaptation of charging profiles to the charging time, charging energy and charging power,
wherein the utilization group model is dynamically structured by the correlation of equivalent utilization groups and/or equivalent user behavior,
wherein the charging column model delivers weather information, occupancy data, functional and capacity data, together with type information on charging columns,
wherein the vehicle model is employed for determining the state-of-charge at the end of the journey, which is also based upon a prediction,
wherein the driver model for ascertaining the anticipated route and individual driver behavior enables a further improvement in the estimation of anticipated energy consumption,
wherein the fleet model aggregates available and calculated data from individual models by way of the customer preference user model, the utilization group model, the charging column model, the vehicle model and the driver model, in order to execute the delivery and transfer, at the network operator interface, of a forecast for the future anticipated location-based power and energy demand.

9. A service package which is set-up by means of the method as claimed in claim 1, comprising data from calculated models which are consolidated into a predictive model which is provided to network operators for the network operation thereof, and a service provision package for subscribed users and at least one network operator.

10. A business model for the supply and commercial sale of calculated data from a predictive model as claimed in claim 1, for a network operator and subscribed users.

11. The method as claimed in claim 1, wherein the sector is defined by a network load model and a network node model.

12. The method as claimed in claim 2, wherein the service provider assumes the provision of services to subscribed users, and the delivery of further services to the at least one network operator.

13. The method as claimed in claim 3, wherein the service provider assumes the provision of services to subscribed users, and the delivery of further services to the at least one network operator.

14. The method as claimed in claim 2, wherein users both supply and consume power.

15. The method as claimed in claim 3, wherein users both supply and consume power.

16. The method as claimed in claim 4, wherein users both supply and consume power.

17. The method as claimed in claim 2, wherein the network operator actively controls their network in the sector, by means of the service provider, such that network capacity utilization at any time is optimized.

18. The method as claimed in claim 3, wherein the network operator actively controls their network in the sector, by means of the service provider, such that network capacity utilization at any time is optimized.

19. The method as claimed in claim 4, wherein the network operator actively controls their network in the sector, by means of the service provider, such that network capacity utilization at any time is optimized.

20. The method as claimed in claim 5, wherein the network operator actively controls their network in the sector, by means of the service provider, such that network capacity utilization at any time is optimized.
